(19) United States
(12) Patent Application Publication
(10) Pub. No.: US 2004/0231178 A1
(43) Pub. Date: Nov. 25, 2004

(54) Apparatus for placing furring straps

(76) Inventor: Leonard Collins, Braintree, MA (US)

Correspondence Address: Jason Bryan, Lambert & Associates, 92 State Street, Boston, MA, 02109-2004, US

(21) Appl. No.: 10/444,736

(22) Filed: May 23, 2003

(51) Int. Cl. G01D 21/00

(52) U.S. Cl. 33/613

(57) ABSTRACT

A device of exact standard dimensions for quickly and efficiently placing furring straps, comprising an elongated body having an abutment shoulder on one end and a cradle on a second end with a handle long enough to enable reaching ceilings.

### BACKGROUND OF INVENTION

This invention relates to precisely and efficient placement standard furring straps in standard arrangement during construction for placement of wallboards.

### BRIEF SUMMARY OF THE INVENTION

In the early days of housing construction much time was consumed in planning and measuring the size of rooms for placement of materials for construction. With the advent of standard sizes for constructing buildings and housing, such construction was completed more efficiently and with greater cost effectiveness. Such standardization of housing sizes allowed for the employment of standard sized furring strips in assembling structural elements for standard sized rooms.

To assemble such structural elements, furring strips were placed by measuring with a tape measure, and marking with chalk. Builders then had to be sure the furring strips were correctly ordered along the chalk markings, as any deviation could disrupt the spacing of the final furring strips in the structural assembly and cause time-consuming adjustments. Accordingly, devices were created which related to the standard sizes and aid in construction to improve accuracy and efficiency.

Such a device is disclosed by a patent issued to Payne, U.S. Pat. No. 5,490,334. This device aids in placing studs in a predetermined spacing distance from one another for constructing the initial structure of a room. This device however is intended for placing studs, and moreover, is typically used in first assembling the structural elements on the floor, and thereafter raising them.

Another device disclosed by a patent granted to Williams, U.S. Pat. No. 4,237,614. Aids in correctly placing furring strips for eventual placement of wallboards. However, the U-shaped end of the device makes it difficult to quickly and easily remove the spacing guide after securing the furring strip. Moreover, the device lacks a handle, thereby inhibiting the ability to easily reach ceilings or positioning for walls. Finally, there is no correctly spaced shoulder with which to place a proximal furring strip.

Because of such difficulties with present devices, and lack of precision and efficiency in assembling structural elements in their upright and final positions, what is needed, therefore, is a device which can quickly and precisely install furring strips in their upright and correctly spaced position on already fixed walls and ceiling structures. An object of this invention is to quickly and precisely place consecutive furring straps. A further object is to space a first furring strap a precise distance from already fixed walls.

### SUMMARY OF THE INVENTION

The present invention advances the art of spacing furring strips with precision and speed in assembling structural elements. Standard structural elements have standard spacing and sizing. More specifically, a standard furring strips is two and one quarter inches in wide. From their center axes, they are spaced exactly sixteen inches from one another. Such furring strap structural elements are assembled in the ceiling and wall areas in order to facilitate the securing of wallboard or ceiling elements to straps.

The present invention has an elongated body with a first end and a second end. The first end has an abutment shoulder. The abutment shoulder has two arms, with one extending perpendicular to the longitudinal length of the device and a second arm extending in the same longitudinal direction of the of the elongated body. The second arm is exactly one and one eighths inches, equal to one half the width of a standard furring strip. The second arm of the abutment shoulder is approximately three quarters inches, but other similar lengths will suffice.

On the second end of the elongated body is a cradle with a primary arm and a secondary arm, both extending perpendicular to the longitudinal direction of the elongated body. The distance between the two arms of the cradle is exactly two and one quarter inches. The distance from the middle of the cradle to the end of the second arm of the shoulder abutment is exactly sixteen inches, and the distance to the first arm is exactly fourteen and seven eighths inches.

The exact lengths are essential to the invention because it is this combination of dimensions that enables the precise and speedy spacing and installation of the structural elements. Because the distance from the end of the second arm of the shoulder abutment to the middle point of the cradle is sixteen inches, this allows the convenient and accurate placing of the proximal furring strip. The one and one eighth inch second arm of the shoulder abutment allows for the shoulder abutment to be placed squarely against the primary wall and a furring strip placed within the cradle at the exact distance of sixteen inches from the middle of the furring strip to the wall. This first placement is significant because an error in spacing will carry over to the distal furring strip and prevent correct placement of the furring strips within the structure.

After the proximal furring strip is placed, the invention can be easily removed and subsequently the shoulder abutment can be placed against the proximal furring strip with the first arm of the shoulder abutment placed against the side of the proximal furring strip and the second arm of the shoulder abutment resting on the top of the furring strip reaching to the middle of the strip.

This allows a second furring strip to be placed in the cradle of the invention and then nailed or attached into place. This process can be repeated until the final distal furring strip is placed, all with precision and speed. Moreover, a handle is attached to the back of the invention long enough to place furring strips in a ceiling. The handle also aids in placing furring strips in a wall without having to assemble on the floor.

These and other features, aspects and advantages of the present invention will become better understood with reference to the following description, claims, and accompanying drawings. Therefore the form of the invention as set out above should be considered illustrative and not as limiting the scope of the following claims.

### BRIEF DESCRIPTION OF DRAWINGS

FIG. 1 is a side elevational view of the strap placement device.

FIG. 2 is a plan view of the strap placement strap device.

FIG. 3 displays the method of placing a proximal furring strap.

FIG. 4 displays the method of placing furring straps relative to each other.

### DETAILED DESCRIPTION OF THE INVENTION

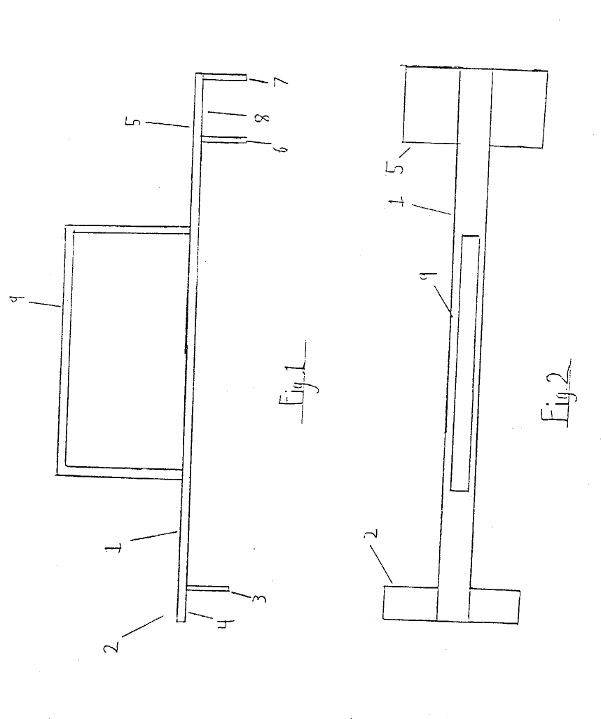

The present invention allows for precisely and speedily placing furring strips. One embodiment is displayed in FIG. 1 having an elongated body 1. On the first end of the elongated body 1 is an abutment shoulder 2. The abutment shoulder has a first arm 3 extending perpendicular to the longitudinal length of the elongated body. The abutment shoulder 2 has a second arm 4 extending in the same longitudinal direction of the elongated body. The length of the second arm 4 of the abutment shoulder 2 is one and one quarter inches. The second end of the elongated body is a cradle 5. The cradle has a primary arm 6 and a secondary arm 7. The length between the primary 6 and secondary arm 7 is two and one quarter inches. The length between the middle 8 of the cradle 5 and the end of the second arm 4 of the abutment shoulder 2 is exactly sixteen inches.

Additionally, a handle 9 is attached to the back of the elongated body 1. In one embodiment the handle 9 is eight inches by eight inches in order to facilitate handling the device and reaching ceilings.

FIG. 2 displays an overhead view of an embodiment of the invention. In one embodiment, the abutment shoulder 2 is four inches in width. Also, the elongated body 1 can be one and three eighths inches in width. Also, the cradle 5 can be four inches in width. Other variations of such widths are possible without affecting the precision and speed of the device.

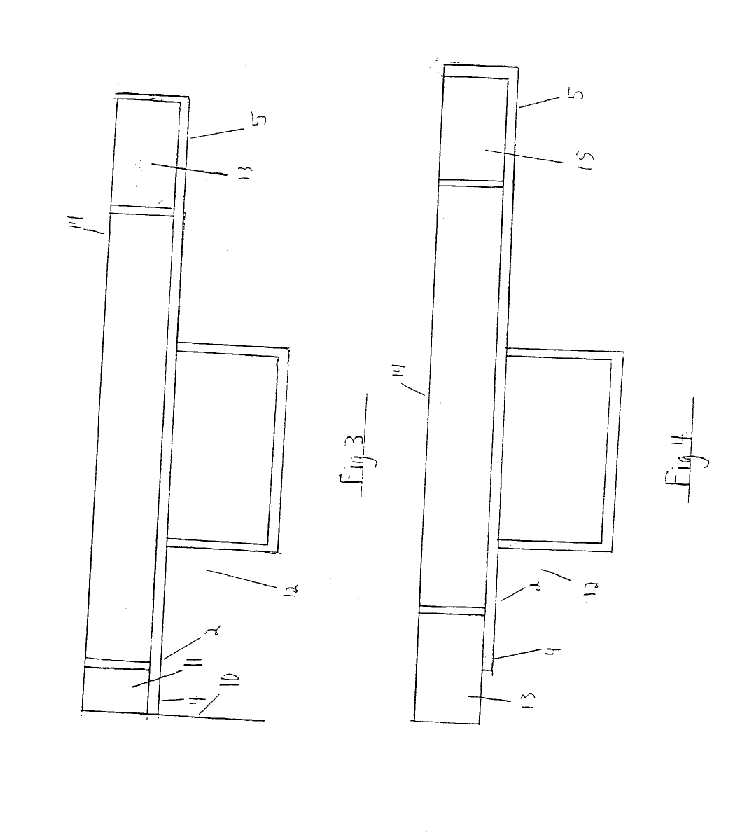

FIG. 3 shows a potential method of operating such a device, where the kwik strap device 12 is placed against a wall 10 and a ceiling structure 14. The device 12 is placed so that second arm 4 of the shoulder abutment 2 is placed against wall 10. This in turn leaves a space 11 inside the shoulder abutment 2. A proximal standard furring strap 13 is placed inside cradle 5 and against ceiling structure 14. This enables the center of the proximal furring strap 13 to be placed exactly sixteen inches from the wall 10. The proximal furring strap 13 can then be secured to the ceiling structure 14.

The next step in the process is displayed in FIG. 4. After the proximal furring strap 13 is secured to the ceiling structure 14, the device 12 can be easily removed and set to place the second furring strap 14. This is done by placing the shoulder abutment 2 against the proximal furring strap 13 with the second arm 4 of the shoulder abutment 2 reaching to the middle of the proximal furring strap 13. The second furring strap 15 would then be placed within the cradle 5 of the device 12 so that the middle of each furring strap is exactly sixteen inches from each other. After the second furring strap is secured to the ceiling structure, the process can be continued indefinitely until the final furring strap is secured to the ceiling or wall structure. Furring straps can then be placed across a wall or ceiling structure with speed and exactitude.

1. A precision strapping device comprising:
an elongated body member having a first end, a second end and a middle portion;
wherein said first end of said elongated body has an abutment shoulder;
wherein said abutment shoulder has a first arm extending perpendicular to said longitudinal direction of said elongated body member;
wherein said abutment shoulder has a second arm extending half a width of a standard furring strip in a same longitudinal direction of said elongated body member beyond said first arm of said abutment shoulder;
wherein said second end has a cradle having a middle point, a primary arm, and a secondary arm;
said primary arm and said secondary arm extend perpendicular to said longitudinal direction of said elongated member
wherein a distance between said middle point of said cradle and the end of said second arm of said abutment shoulder is equal to a standard distance between standard furring strips;
wherein a distance between said primary and said secondary arm of said cradle is equal to said distance of said standard furring strip.

2. (canceled)

3. (cancelled)

4. (cancelled)

5. Device of claim 1 wherein:
said distance between said middle point of said cradle and said first arm of said abutment shoulder is fourteen and seven eighths inches.

6. Device of claim 1 wherein:
said distance between said middle point of said cradle and an end of said second arm of said abutment shoulder is sixteen inches.

7. Device of claim 1 wherein:
said elongated body has a handle extending perpendicular to said longitudinal direction of said elongated body.

8. (cancelled)

9. Device of claim 7 wherein:
said handle has a length of one inch to four feet.

10. Device of claim 7 wherein:
said handle has a length of eight inches, and said handle extends a perpendicular distance of eight inches from said longitudinal direction of said elongated body.

11. A method of precisely positioning furring strips comprising:
attaching an abutment shoulder to a first end of an elongated body so that a first arm extends perpendicular to a longitudinal direction of said elongated body and a second arm extends beyond said longitudinal length of said elongated body half a the width of a standard furring strip;
attaching a cradle to a second end of said elongated body so that a primary and secondary arm extend perpendicular to said longitudinal direction of said
elongated body, and wherein a distance between a middle point of said cradle and an end of said second arm of said abutment shoulder is equal to a standard distance between standard furring strips;
placing said shoulder abutment so that an end of said second arm of said shoulder abutment is pressed against said wall;
placing a proximal furring strip within said cradle;
securing said proximal furring strap onto support structure;
placing said shoulder abutment so that said first arm of said shoulder abutment is pressed against said proximal furring strap;
placing secondary furring strap in said cradle;
nailing said secondary furring strap into said support structure.

12. A method of precisely positioning furring strips comprising:
attaching an abutment shoulder to a first end of an elongated body so that a first arm extends perpendicular to a longitudinal direction of said elongated body and a second arm extends beyond said longitudinal length of said elongated body half a width of a standard furring strip;
attaching a cradle to a second end of said elongated body so that a primary and secondary arm extend perpendicular to said longitudinal direction of said elongated body, and wherein a distance between a middle point of said cradle and an end of said second arm of said abutment shoulder is equal to a standard distance between standard furring strips;
placing said shoulder abutment so that said first arm of said shoulder abutment is pressed against a proximal furring strap;
placing secondary furring strap in said cradle;
securing said secondary furring strap onto said support structure.
